(19) United States
(12) Patent Application Publication
(10) Pub. No.: US 2015/0011137 A1
(43) Pub. Date: Jan. 8, 2015

(54) SHOWER CURTAIN WITH ANTI-FOULING FACILITY AND METHOD FOR THE PRODUCTION THEREOF

(71) Applicant: Wenko-Wenselaar GmbH & Co. KG, Hilden (DE)

(72) Inventor: Hanns-Joachim Köllner, Dusseldorf (DE)

(21) Appl. No.: 14/373,377

(22) PCT Filed: Jan. 31, 2013
(86) PCT No.: PCT/DE2013/100034

§ 371 Date: Jul. 21, 2014

(30) Foreign Application Priority Data
Feb. 9, 2012 (DE) 20 2012 100 443.7
Apr. 19, 2012 (DE) 10 2012 103 438.9

(51) Int. Cl. C09D 5/16; B05D 1/18; D06M 15/263; B05D 3/10; B05D 5/00; A01N 43/38; A47K 3/38; B05D 3/02

(52) U.S. Cl. CPC C09D 5/1662; A47K 3/38; B05D 1/18; B05D 3/0254; B05D 3/108; B05D 5/00; A01N 43/38; D06M 15/263; D06M 2101/32
USPC 442/83; 442/79; 427/393.4; 427/258; 427/392

(57) ABSTRACT

Shower curtain with anti-fouling facility and method for the production thereof, the shower curtain having an openly cross-linked, multicomponent polycondensate anchored on its fabric, said polycondensate repelling liquid water and having at least the partial condensates of the starting materials a) acrylate prepolymer, b) aliphatic diol, and c) zinc-organic compound with hydroxyl group, remainder adjuvants, additives and unavoidable impurities.

### TECHNICAL FIELD

The present invention relates to a shower curtain as in the preamble of the independent claims.

U.S. 2011/0 217 348 A1 provides general approaches to solution-chemistry methods for the provision of antifouling treatment to textile substrates. Said document claims the use of resultant substrates in the field of nets for fisheries and for aqua culture. However, a problem here is that these nets have long periods of exposure to water. The antifouling treatment must therefore disadvantageously be almost insoluble in water, in order that it is not leached out by seawater within a short time. In the light of this, the question here is which of the treatment systems disclosed in general terms in said document could be at all suitable for a shower curtain which has only periodic contact with water and which becomes colonized by mold that thrives in moist conditions. It cannot be assumed that the treatment systems disclosed in said document have adequate activity on the resultant textile surface of a shower curtain, in the absence of long periods of contact with water.

WO 2005 123 891 A2 discloses, as alternative to solution-chemistry treatment methods, a vacuum-plasma process in which bonding components are mixed with inert components and, in a vacuum-plasma chamber, are deposited in an intimately molecularly homogenized mixture on a cleaning textile for household use. Although it can be assumed that said textiles are likewise moistened only for periods for the polishing/cleaning process, a vacuum-plasma process requires a disadvantageously high level of technical resource, and incurs high manufacturing costs.

WO 2008 051 756 A2 discloses coating by a solution-chemistry method: an aqueous thermoplastic resin mixture can provide a bonding matrix during the shaping or extrusion of glassfiber-based or glass-based moldings or textiles. However, it remains questionable here whether and how that type of matrix could serve as reservoir for treatment with an active ingredient. The properties that said matrix could have in a fabric which comprises no glass fibers at all and which does not have to be molded are moreover subject to question. This latter question is specifically of relevance here because traditional shower curtains do not require any glassfiber reinforcement, and comprise no glass particles.

In the light of this general technical background, a question that then arises is: which treatments applied by solution-chemistry methods can provide an effective antifouling treatment for a shower curtain.

### DESCRIPTION OF THE PRIOR ART

Shower curtains of this generic type have an antifouling treatment intended to prevent any outcome in which a shower curtain subjected to regular soaking is colonized by microbes and/or mold specifically in the slow-drying regions having lateral contact with the shower tray or bath, and thus becomes visually unattractive. Another result here is prevention of any unacceptable contamination of the bathing area by pathogenic colonies of mold or of microbes.

DE 203 06 281 U1 discloses a shower curtain treated with a microbicidal solution based on an ionic system.

A disadvantage of shower curtains of this generic type is that the active ingredients introduced to counter colonization by microbes and/or mold have to have high effectiveness and also solubility in water, so that they can also reach microbes that thrive in an aqueous environment and can at least inhibit the growth thereof. However, because the active ingredients have to be soluble in water, when the shower is operated they pass directly into the wastewater and into downstream water-treatment systems, where they are extremely effective in killing the bacteria in the water-treatment sludge. Furthermore, the active ingredients are rapidly removed by this leaching process, and the desired long-term effect of the active ingredients is therefore often not ensured.

It was therefore an object of the present invention to overcome the disadvantages of the prior art and to provide a shower curtain which has an antifouling treatment and which is equally capable of complying with the contradictory requirements of dependable effectiveness of the microbicidal components and of the necessary long-term effect.

This object is achieved in accordance with the features of the independent claims. Advantageous embodiments are found in the dependent claims, and also in the description hereinafter.

### SUMMARY OF THE INVENTION

In the invention, a shower curtain with antifouling treatment comprises, anchored on its fabric, a liquid-water-repellant, open-crosslinked, multicomponent polycondensate. The polycondensate comprises at least the partial condensates of the following starting materials:
a) acrylate prepolymer,
b) aliphatic diol, and
c) organozinc compound having hydroxy group,
d) remainder being auxiliaries, additions, and unavoidable contaminants.

### DESCRIPTION OF THE INVENTION AND OF ADVANTAGEOUS FEATURES

Fabric here means the underlying material which is present in the shower curtain and which comprises cotton, wool, plastic, and/or mixtures of the various types of material. This fabric can advantageously have been printed, in order to provide the shower curtain with visual features appropriate to particular equipment styles and design styles.

A polycondensate here means a structure/polymer obtained from various components via condensation—i.e. via concentration by evaporation with removal of the cleavage products produced during the bonding process. The structure then comprises the various components as incorporated units. The synonymous expression partial condensates is used hereinafter for these units, which are previously free components that have been bonded into the material during the course of the condensation process and are part of the structure. A polycondensation process with elimination of water appears not to be very advantageous here because it can be subject to a reverse reaction which could dissolve the polycondensate and remove it prematurely from the shower curtain. Surprisingly, the inventors have found that a polyacrylate-based polycondensate combined with crosslinking, aliphatic compounds having hydroxy functions provides a condensate which is made of components crosslinked and bonded to one another and which provides not only stability of the condensate but also long-term effectiveness of the components.

The polyacrylate-based polycondensate is anchored on the fabric. To this end, the fabric is placed into an—advantageously prepolymerized—acrylate bath until the saturation achieved, in terms of increasing weight, is at least 80%, based on the drip-dry weight of a fully saturated fabric. The fabric is then removed from the bath, and the acrylate prepolymer is condensed to give the crosslinked polyacrylate, in order to apply a liquid-water-repellant condensate at least over the entire external area of the shower curtain.

Prepolymer here means the monomeric or oligomeric precursor of the polyacrylate; acrylate monomers here comprise acrylic acid molecules having C—C double-bond function and acid function, and mixtures of acrylic acid molecules with alcohols with a plurality of OH groups and optionally COOH groups. Oligomeric prepolymers are partially precrosslinked/precondensed macromolecules which advantageously, being unitary, relatively large structural elements of the desired polycondensate, then finally merely require anchoring on the fabric and crosslinking to one another. Oligomeric prepolymers advantageously permit more precise control of uniformity of degree of crosslinking of the resultant polycondensate. It is particularly advantageous here that hydrophobic active ingredients are introduced concomitantly in a carrier that is an oligomeric prepolymer with gas-permeable structure, into the polycondensate.

The inventors assume that use of the additional components having hydroxy function achieves an open-crosslinked, multicomponent polycondensate which, although it permits the passage of water vapor, develops a hydrophobic barrier effect in relation to liquid water directly in contact therewith. The polycondensate here comprises at least the partial condensates of the following starting materials: a) acrylate prepolymer, b) aliphatic diol, and c) organozinc compound having hydroxy group. While the polyacrylate provides an underlying structure constructed by way of C—C bridges and/or ester bridges, the diol is capable of formation of further ester bridges of R—CO—O—R′ type with free, organic acid groups, with elimination of water, and of introduction of additional crosslinking into the condensate. The organozinc compound having hydroxy group can be bonded into the condensate by way of hydrogen bonds, ether bridges of the type R—O—R′, or else ester bridges of the type R—CO—O—R′. These various possibilities for bonding and association known from the field of terpolymers are deemed by the inventors to be responsible for the fact that, contrary to expectation, it was possible to obtain a polycondensate that permits diffusion. If the polycondensate was impermeable, the microbicidal components would be fixedly enclosed therein, and would be unable to develop any kind of effect. However, the microbicidal effect was detected in extensive experiments, although the microbicidal components were not detectable in water droplets running off from the surface. The inventors assume that the polycondensate has open pores with channels that permit passage, by way of which the components can pass in the form of gas to the external area of the shower curtain, where they can become effective. This diffusion, which is assisted via water vapor, which can activate the components, is effective in countering microbial colonization under moist conditions, whereas under dry conditions there is no possibility of release of the active ingredients anchored within the polycondensate with elimination of water. The inventors' explanation described above can form a rational basis for the possibility of using a polycondensate to provide the fundamentally water-soluble active ingredients for the first time as long-term active ingredient in a shower curtain. The shower curtain can, of course, comprise auxiliaries, additions, and unavoidable contaminants, as long as the effectiveness described above for microbicidal active ingredients is retained.

Auxiliaries preferably comprise adhesion promoters in the form of polymerizable, particularly preferably prepolymerized polymerizable, compounds which are introduced previously and/or simultaneously with the polycondensate, and develop adhesion-promoting, preferably also water-impermeable, structures between the fabric and the polycondensate. It is preferable that auxiliaries comprise polymerizable compounds which, in a form thermally crosslinked by using the double bond of the acrylate structural groups in the polycondensate, particularly preferably in the context of final hardening and drying at from 60 to 200° C., preferably from 70 to 180° C., particularly preferably 100+−40° C., are introduced with stabilizing effect concomitantly into the coating. It is particularly preferable that the shower curtain has a respectively different internal and external side, where one side has been treated with the antifouling treatment; the single-side treatment can thus be applied specifically in predetermined regions of folding which dry slowly and are therefore susceptible to colonization, whereas rapid-drying, convexly curved regions/external regions equally have adequate protection through the fabric with lower activity of the active antifouling ingredients; it is thus preferable to use an asymmetric shower curtain for advantageous achievement of very good effectiveness while the total quantity of active ingredient is reduced.

It is preferable that the shower curtain is characterized in that aliphatic diols of the group b) have a longest, unbranched chain of from 4 to 8 C atoms. Use of diols of this size/length for crosslinking advantageously achieves a polycondensate that permits diffusion, with a more uniform pore structure.

It is preferable that the shower curtain is characterized in that the polycondensate comprises a benzimidazole compound as addition. Benzimidazoles have fungicidal or else biocidal/antimicrobial properties, depending on their structure. The aromatic structure of the underlying compound here gives it hydrophobic properties, i.e. the extent to which aqueous systems can dissolve these active ingredients out from an underlying structure is very small, but when spores or microbes achieve direct penetration said ingredients advantageously counter colonization in the interior of the condensate. It is particularly preferable that the shower curtain is characterized in that the polycondensate comprises 2-(4-thiazolyl)-1H-benzimidazole as addition. With this benzimidazole it was possible to achieve particularly advantageous growth-inhibiting and microbicidal effects in relation to fungi and microbes in combination.

It is preferable that the shower curtain is characterized in that the polycondensate comprises, as diol, 2-methylpentane-2,4-diol as starting diol of the group b). By virtue of the additional substituents, the OH groups of this diol have stronger steric orientation; the inventors consider that this is responsible for the achievement, with use of this diol, of a markedly more uniform coating with microbicidal impregnation system having the same effectiveness over an entire area. The improved uniformity can be explained in terms of more uniform orientation of the diol and, resulting therefrom, uniform pore structure in the polycondensate.

It is preferable that the shower curtain is characterized in that the polycondensate comprises bis(1-hydroxy-2(1H)-pyridinethionato-O,S)-(T-4)-zinc as compound of the group c). Organometallic complexes and compounds are known for their antifouling properties, but are subject to criticism because of their toxicity. The inventors consider it likely here that there is additional fixing of this active ingredient component within the polycondensate via the aromatic structure, in a manner similar to that for the benzimidazoles. It is thus advantageously possible to anchor a highly effective component by way of the polycondensate and, in the context of the condensation process, indeed to bond a proportion of same concomitantly into the polycondensate structure. It is thus possible to explain the particular resistance to colonization of the resultant polycondensate coating.

It is preferable that the shower curtain is characterized in that the polycondensate comprises, as additional substance, a deodorant. A deodorant is effective in countering the types of unpleasant odors that can enter the bath by way of the outflow. This can be countered by decomposition of the molecules responsible, or by covering the odors with pleasant odors that are perceived as stronger. It is particularly preferable that the deodorant is introduced in the form of moisture-activatable deodorant which can be dissolved and liberated only on contact with water. In combination with the claimed polycondensate, access is thus provided to a deodorant which provides a dependable supplementary long-term effect and which is capable, via a continuing “fresh odor”, of indicating any exhaustion of the storage capacity of the long-term reservoir within the polycondensate. It is particularly preferable that, to this end, the shower curtain has been treated with a heat-activatable fragrance carrier as addition which clearly indicates in a pleasant manner the storage capacity of the polycondensate during each use/each shower.

It is preferable that the shower curtain is characterized in that the polycondensate comprises at least one particulate, inorganic optical brightener selected from the group consisting of silicon oxides, titanium dioxide, zirconium dioxide, magnesium oxide, zinc oxide, tin oxide. This type of addition increases the UV resistance of the fabric and also avoids any catalytic reaction of the microbicidal components. It is moreover particularly advantageous to achieve a lightfast color shade which has high visual whiteness and which, particularly in the case of printed shower curtains, ensures, for the long term, that the underlying color and background color of the fabric is colorfast and provides high contrast.

It is preferable that the claimed shower curtain is attained via a process which comprises the following steps: a4) placement of a fabric into an acrylate bath comprising at least one aliphatic diol, one organozinc compound having hydroxy group, remainder being auxiliaries, additions, and unavoidable contaminants, b) removal of the least 80% saturated fabric, c) final condensation and crosslinking

Further advantages are apparent from the inventive examples. The features and advantages described above, and the inventive examples hereinafter, are of course not to be interpreted as restrictive. Advantageous additional features and additional feature combinations as explained in the description can, for the purposes of the independent claims, be realized either individually or else in combination in the subject matter claimed, without exceeding the scope of the invention.

### DETAILED EXPLANATION OF THE INVENTION WITH REFERENCE TO INVENTIVE EXAMPLES

In a particularly advantageous embodiment, the shower curtain with antifouling treatment comprises, anchored on its fabric, a liquid-water-repellent, multicomponent polycondensate crosslinked in a manner that permits gas diffusion. The polycondensate comprises the partial condensates of the following starting materials: a) a quantity of from 1 to 3 percent by weight, based on the underlying weight of the untreated shower curtain, of acrylate prepolymer, b) a quantity of from 0.05 to 0.25 percent by weight, based on the underlying weight of the untreated shower curtain, of 2-methylpentane-2,4-diol, c) a quantity of from 0.1 to 0.3 percent by weight, based on the underlying weight of the untreated shower curtain, of bis(1-hydroxy-2(1H)-pyridine [symbol] thionato-O,S)-(T-4)-zinc, a quantity of from 0.1 to 0.3 percent by weight, based on the underlying weight of the untreated shower curtain, of 2-(4-thiazolyl)-1H-benzimidazole, remainder being auxiliaries and unavoidable contaminants.

The shower curtain was manufactured via immersion in a treatment bath with the abovementioned components, and final condensation. The shower curtain was then washed and dried. In a particularly preferred embodiment, the treatment took place on the internal side of the curtain with final drying/hardening at about 150° C.+−30° C. The microbicidal effect of the resultant shower curtain was tested.

A segment of the fabric was applied in accordance with DIN EN ISO 20645 on agar plates, and each agar plate was inoculated firstly with Staphylococcus aureus ATCC 6538 and secondly with Escherichia coli ATCC 11229. Both cultures exhibited an antibacterial effect in the form of an inhibition halo which became visible around the respective segment: Staphylococcus aureus ATCC 6538 was capable of colonization only as far as a distance of 6 mm from the segment, while Escherichia coli ATCC 11229 was capable of colonization only as far as a distance of 1.5 mm from the segment on the agar plate. A test carried out in accordance with DIN EN 1104 for effectiveness against Aspergillus niger DSM 1957 led to an inhibition halo of only 0.5 mm around the cut edges of the fabric segment. The inventors attribute the slow migration rates of the fungicidal, hydrophobic constituents to the small-pored character of the polyacrylate condensate obtained with elimination of water, and the long-term effect of the active ingredients can also be explained via said character. An antibacterial/fungicidal effect was thus proven for the shower curtain and, by using a model consistent therewith, could be attributed to the multicomponent character of the polyacrylate-based polycondensate.

A particularly advantageous process gives a shower curtain of the invention with advantageous stability and with antifouling treatment that is more uniform and that lasts longer. The advantageous process comprises the following steps: a0) at least printing of the external side of the fabric, which is composed of polyester, a1) full-surface application, on the fabric, of a primer together with a crosslinkable, acrylate-compatible prepolymer with an average agglomerate size of from 1 to 50 micrometers, a2) start of the crosslinking reaction in the prepolymer/primer applied, a3) provision of the acrylate bath which comprises from 1 to 5 parts by weight of acrylic acid,—from 1 to 5 parts by weight of n-butyl acrylate,—from 1 to 5 parts by weight of ethyl acrylate,—from 1 to 2 parts by weight of aliphatic diol,—from 2 to 4 parts by weight of organozinc compound having hydroxy group,—addition at least comprising from 2 to 4 parts by weight of benzimidazole compound,—auxiliary at least comprising a crosslinking inhibitor deactivatable by temperatures above 80° C.,—remainder being water, optional auxiliaries, optional additions, and unavoidable contaminants, a4) placement of the fabric into the acrylate bath with interruption of the crosslinking reaction in the prepolymer, b) removal of the at least 80% acrylate-bath-saturated fabric, c1) predrying and beginning of condensation, c2) heating of the internal side of the fabric to (120 +−40)° C. with deactivation of the inhibitor, then with crosslinking and with simultaneous, final condensation. These combined measures give a layer which exhibits particularly stable adhesion and uniform antifouling treatment, as explained in detail hereinafter:

A polyester fabric is first printed at least on the external side. “External side” here means that external side of the shower curtain that is visible from the outside when the curtain has been drawn, while the internal side of the curtain faces toward the shower space. Printing inks used can particularly advantageously be UV-resistant pigment inks, which provide good, stable color intensity for a period of years; the print is particularly advantageously combined with an addition of UV-protective substance such as titanium dioxide, in order to provide comprehensive long-term protection of the print from fading or discoloration.

A feature of a shower curtain manufactured from polyester, in comparison with fabrics based on natural materials, is advantageous strength and dimensional stability, and the former is clearly superior to the natural materials in particular in its resistance to wear.

The entire surface of the printed polyester-based fabric is then provided with a primer. “Primer” here means a component or mixture that optimizes the adhesion of an underlying layer.

Known measures comprise by way of example application of an adhesion promoter—comprising acrylates, tannins, antimony potassium tartrate, quaternary amine compounds, silanes, polysilazanes, organosiloxanes—in combination with measures such as rendering the surface to be coated accessible by treatment with acids or alkalis, plasma treatment or corona treatment, and plasma oxidation/plasma polymerization.

In the present case, an advantageous adhesion promoter is applied in the form of an organosiloxane with an acrylate-compatible, crosslinkable prepolymer. Particularly uniform, crosslinkable layers with dependable adhesion-promoting properties were formed by methacrylic-acid-substituted trimethoxysilane as organosiloxane in combination with a prepolymer that had optionally been cohydrolyzed. DE 24 22 428, the entirety of which is incorporated herein by way of reference, provides illustrative examples of other adhesion promoters, cohydrolyzable mono- and polymers, and suitable reaction procedures for the production of these primers; the photocoating described in that document proved to be primer systems with surprisingly good suitability for the present process. It is particularly advantageous to use an acrylate-based prepolymer the reaction of which is relatively easily controllable in the same way as the subsequent acrylate bath by way of the same inhibitors, and which requires no additional additives.

The average agglomerate size of the prepolymer is from 1 to 50 micrometers. With agglomerate sizes in the micrometer range it was possible to achieve smooth and evenly dimensioned primer films which, after brief, light-induced crosslinking, had advantageous good adhesion on the polyester. Monomer compositions were not always dependably capable of providing, within a short reaction time, the adhesion that is necessary for further processing, while agglomerates in the millimeter range become clearly visible, and impair the appearance of the print.

The anchoring crosslinking of the prepolymer can advantageously and easily be achieved photochemically by way of a flashlight/exposure of the uniformly thinly distributed primer/prepolymer layer to controlled, relatively bright light. The crosslinking polymerization that begins anchors the prepolymer sufficiently securely within a short time.

Introduction of the fabric, provided with a primer with crosslinking prepolymer, into the acrylate bath described above which comprises a crosslinking inhibitor as stabilizer for the acrylates present therein brings the crosslinking in the primer/prepolymer layer to a standstill. Plenty of time is therefore available for uniform distribution and application of the treatment solution in the acrylate bath until the resultant layer is uniform and evenly dimensioned, and has good optical quality.

This reaction procedure has the particular advantage that during the subsequent predrying a proportion of water is first removed and a first condensation process is brought about. At a temperature of 80° C. or above the crosslinking inhibitor is deactivated, and the crosslinking of the double bonds of the acrylic acid compounds begins again. At the same time, the parallel condensation of hydroxy groups and acid groups brings about the liberation and evolution of water. The inventors assume that as the water is evolved it generates microfine channels uniformly throughout the treatment layer during the crosslinking process, and that the components active against colonization can subsequently develop their activity by way of said channels; this explains the fact that the effectiveness of the shower curtains advantageously coated as described is markedly more uniform, and more durable over the entire area.

The acrylic acid content of the acrylate bath provides additional, condensable acid groups, while the alkyl groups of the alkyl acrylates also present generate a steric requirement for greater molecular separations during the crosslinking process, and thus additionally assist achievement of a more open structure.

It is particularly advantageous that the interrupted crosslinking reaction of the primer/prepolymer layer ensures that the crosslinking process concomitantly bonds acrylate from the acrylate bath uniformly into the primer/prepolymer layer, and this explains the markedly better adhesion and resistance to shear and to peeling on repeated creasing of the treated fabric, as found on samples produced in accordance with the process.

The heating of the internal side of the fabric—by way of example by means of a radiant heater or of a steam of hot air—heats a print on the external side only through the fabric; the heating on the external side is thus less drastic, the crosslinking reaction takes place more slowly and more uniformly, and the visual effect of the printed image advantageously remains entirely unaltered.

1. A shower curtain with antifouling treatment, comprising, anchored on its fabric, a liquid-water-repellant, open-crosslinked, multicomponent polycondensate which comprises the partial condensates, introduced by way of an acrylate bath, and bonded together into a structure with elimination of water, of the following starting materials:
a) acrylate prepolymer,
b) aliphatic diol, and
c) organozinc compound having hydroxy group,
remainder being auxiliaries, additives, and unavoidable contaminants,
where wherein the fabric comprises one of the following types of material: cotton, wool, plastic, and/or mixtures of these types of material.

2. The shower curtain of claim 1, wherein the aliphatic diol has a longest, unbranched chain of from 4 to 8 carbon atoms.

3. The shower curtain of claim 1, wherein the polycondensate comprises a benzimidazole compound as an additive.

4. The shower curtain of claim 3, wherein the polycondensate comprises 2-(4-thiazolyl)-1H-benzimidazole as an additive.

5. The shower curtain of claim 1, wherein the polycondensate comprises, as the aliphatic diol, 2-methylpentan-2,4-diol.

6. The shower curtain of claim 1, wherein the polycondensate comprises bis(1-hydroxy-2(1H)-pyridinethionato-O,S)-(T-4)-zinc as the organozinc compound.

7. The shower curtain of claim 1, wherein the polycondensate comprises, as an additive, a deodorant.

8. The shower curtain of claim 1, wherein the polycondensate comprises, as an additive, a heat-activatable fragrance carrier.

9. The shower curtain of claim 1, wherein the polycondensate comprises further at least one particulate, inorganic optical brightener selected from the group consisting of silicon oxides, titanium dioxide, zirconium dioxide, magnesium oxide, zinc oxide, tin oxide.

10. The shower curtain of claim 1, comprising anchored on its fabric, a liquid-water-repellent, multicomponent polycondensate which has been crosslinked in a manner that permits gas diffusion and which comprises the partial condensates of the following starting materials:
a) a quantity of from 1 to 3 percent by weight, based on the underlying weight of the untreated shower curtain, of acrylate prepolymer,
b) a quantity of from 0.05 to 0.25 percent by weight, based on the underlying weight of the untreated shower curtain, of 2-methylpentane-2,4-diol,
c) a quantity of from 0.1 to 0.3 percent by weight, based on the underlying weight of the untreated shower curtain, of bis(1-hydroxy-2(1H)-pyridinethionato-O,S)-(T-4)-zinc,
a quantity of from 0.1 to 0.3 percent by weight, based on the underlying weight of the untreated shower curtain, of 2-(4-thiazolyl)-1H-benzimidazole,
remainder being auxiliaries and unavoidable contaminants.

11. A process for the production of a shower curtain claim 1, the process comprising the following steps:
a4) placement of a fabric into an acrylate bath comprising at least one aliphatic diol, one organozinc compound having hydroxy group, remainder being auxiliaries, additions, and unavoidable contaminants,
b) removal of the least 80% saturated fabric,
c) final condensation with elimination of water and crosslinking.

12. A process for the production of a shower curtain with antifouling treatment, wherein
the shower curtain produced has, anchored on its fabric, a liquid-water-repellant, open-crosslinked, multicomponent polycondensate,
the fabric comprises one of the following types of material, cotton, wool, plastic, and/or mixtures of these types of material,
the polycondensate comprises the partial condensates, introduced by way of an acrylate bath, and bonded together into a structure with elimination of water, of the following starting materials: acrylate prepolymer, aliphatic diol, and organozinc compound having hydroxy group, remainder being auxiliaries, additions, and unavoidable contaminants,
the process comprising the following steps:
a0) at least printing of the external side of the fabric, which is composed of polyester,
a1) full-surface application, on the fabric, of a primer together with a crosslinkable, acrylate-compatible prepolymer with an average agglomerate size of from 1 to 50 micrometers,
a2) start of the crosslinking reaction in prepolymer/primer applied,
a3) provision of the acrylate bath which comprises
from 1 to 5 parts by weight of acrylic acid,
from 1 to 5 parts by weight of n-butyl acrylate,
from 1 to 5 parts by weight of ethyl acrylate,
from 1 to 2 parts by weight of aliphatic diol,
from 2 to 4 parts by weight of organozinc compound having hydroxy group,
addition at least comprising from 2 to 4 parts by weight of benzimidazole compound,
auxiliary at least comprising a crosslinking inhibitor deactivatable by temperatures above 80° C.,
remainder being water, optional auxiliaries, optional additions, and unavoidable contaminants,
a4) placement of the fabric into the acrylate bath with interruption of the crosslinking reaction in the prepolymer/primer,
b) removal of the at least 80% acrylate-bath-saturated fabric,
c1) predrying and beginning of condensation,
c2) heating of the internal side of the fabric to (120+−40)° C. with deactivation of the inhibitor, then with crosslinking and with simultaneous, final condensation.

13. The shower curtain of claim 2, wherein the polycondensate comprises a benzimidazole compound as an additive.

14. The shower curtain of claim 13, wherein the polycondensate comprises 2-(4-thiazolyl)-1H-benzimidazole as an additive.

15. The shower curtain of claim 2, wherein the polycondensate comprises, as diol the aliphatic diol, 2-methylpentan-2,4-diol.

16. The shower curtain of claim 2, wherein the polycondensate comprises bis(1-hydroxy-2(1H)-pyridinethionato-O,S)-(T-4)-zinc as the organozinc compound.

17. The shower curtain of claim 2, wherein the polycondensate comprises, as an additive, a deodorant.

18. The shower curtain of claim 2, wherein the polycondensate comprises, as an additive, a heat-activatable fragrance carrier.

19. The shower curtain of claim 2, wherein the polycondensate comprises at least one particulate, inorganic optical brightener selected from the group consisting of silicon oxides, titanium dioxide, zirconium dioxide, magnesium oxide, zinc oxide, tin oxide.

20. The shower curtain of claim 2, comprising, anchored on its fabric, a liquid-water-repellent, multicomponent polycondensate which has been crosslinked in a manner that permits gas diffusion and which comprises the partial condensates of the following starting materials:
a) a quantity of from 1 to 3 percent by weight, based on the underlying weight of the untreated shower curtain, of acrylate prepolymer,
b) a quantity of from 0.05 to 0.25 percent by weight, based on the underlying weight of the untreated shower curtain, of 2-methylpentane-2,4-diol,
c) a quantity of from 0.1 to 0.3 percent by weight, based on the underlying weight of the untreated shower curtain, of bis(1-hydroxy-2(1H)-pyridinethionato-O,S)-(T-4)-zinc,
a quantity of from 0.1 to 0.3 percent by weight, based on the underlying weight of the untreated shower curtain, of 2-(4-thiazolyl)-1H-benzimidazole,
the remainder being auxiliaries and unavoidable contaminants.
